(19) United States
(12) Patent Application Publication
(10) Pub. No.: US 2019/0170686 A1
(43) Pub. Date: Jun. 6, 2019

(54) OPERATION METHOD OF ELECTROCHEMICAL ANALYZER

(71) Applicant: Zensor R&D Company, Taichung City (TW)

(72) Inventor: Hsieh-Hsun CHUNG, Taichung City (TW)

(21) Appl. No.: 15/987,247

(22) Filed: May 23, 2018

(30) Foreign Application Priority Data
Dec. 5, 2017 (CN) 201721672180.3

(51) Int. Cl. G01N 27/48; G01N 27/416; G01N 27/49; G06F 3/06

(52) U.S. Cl. CPC G01N 27/48; G01N 27/4163; G06F 3/0679; G06F 3/0604; G06F 3/0659; G01N 27/49

(57) ABSTRACT

Provided is an operation method of an electrochemical analyzer, comprising the following steps: preparing a computer including a processor and a memory, and configure an online electrochemical analysis setting process by the computer; configuring a conversion formula and a reaction temperature correction formula, convert an initial test data of an analyte and a corresponding electrochemical analysis method to a test result of the analyte; burning the settings processed in a process editing program into a portable chip; connecting the portable chip to the electrochemical analyzer, disconnect the electrochemical analyzer from the computer, receive a sample through an analysis chip, perform an offline electrochemical analyzing process by the electrochemical analyzer to conduct electrochemical analysis to the sample, and display the test result of the sample on a display unit of the electrochemical analyzer.

### CROSS-REFERENCE TO RELATED APPLICATION

This application claims the benefit of China Patent Application No. 201721672180.3, filed on Dec. 5, 2017, in the State Intellectual Property Office of the People's Republic of China, the disclosure of which is incorporated herein in its entirety by reference.

### BACKGROUND OF THE INVENTION

### 1. Field of the Invention

The present invention relates to an operation method of an electrochemical analyzer, in particular to an operation method of an electrochemical analyzer which conducts electrochemical analysis to a sample through the analyzing process being configured and burned into a portable chip.

### 2. Description of the Related Art

Conventional electrochemical analysis devices are often used in laboratories as the equipment for detecting or analyzing sample content or concentration, and usually the design of such devices does not take size or space consumption into consideration, therefore most electrochemical analysis devices are difficult to carry around due to the large size of the equipment. As a result, samples must be carried back to the lab in order to perform analysis, which substantially limits the time efficiency in practice.

On the other hand, electrochemical analysis devices known in the art usually only receive the sample and produce electrochemical reactions, and need to send the detected potential or current signal back to the connected computer or workstation in order to perform further electrochemical analysis procedures, such as signal interpretation or conversion procedures. Therefore, under such configurations, the electrochemical analysis device must be connected to a computer in order to operate, and cannot be utilized offline and independently, which limits the convenience in use. Recently, although a few portable electrochemical analysis devices have been developed, they are only designed towards the detection of a specific analyte, such as blood glucose meters to measure glucose. Those specific electrochemical analysis devices are unavailable to alter the settings such as analyzing process or control parameters to be able to target different analytes.

From this point of view, the development of an electrochemical analysis device which is not limited to a specific analyte, and able to operate independently when performing detection without the need to connect to other analysis instruments to operate have been demanded.

### SUMMARY OF THE INVENTION

In view of the technical problems above, it is an objective of the present invention to provide an operation method of an electrochemical analyzer, in order to improve the shortcomings of existing electrochemical analysis devices including the requirement to be connect to a computer, unable to be carried around while operating, and unavailable to change the target analyte.

To achieve the foregoing objective, the present invention provides an operation method of an electrochemical analyzer, the operation method comprises the following steps: preparing a computer including a processor and a memory, and configure an online electrochemical analysis setting process by the computer; configuring a conversion formula and a reaction temperature correction formula through a process editing program, convert an initial test data of an analyte and a corresponding electrochemical analysis method to a test result of the analyte; burning the settings processed in the process editing program into a portable chip through the processor; connecting the portable chip to the electrochemical analyzer, disconnect the electrochemical analyzer from the computer, receive a sample through an analysis chip, perform an offline electrochemical analyzing process by the electrochemical analyzer to conduct electrochemical analysis to the sample, and display the test result of the sample on a display unit of the electrochemical analyzer.

Optionally, the online electrochemical analysis setting process comprises the following steps: executing the process editing program stored in the memory through the processor; selecting a plurality of analyzing process through the process editing program, and configure a processing order of the plurality of analyzing process; configuring the analyte and the corresponding electrochemical analysis method through the process editing program, and configure a plurality of control parameters.

Optionally, the plurality of analyzing processes include a sample detection process, an electrochemical analysis initiation process, a detection signal capturing process, or a detection signal conversion process.

Optionally, the electrochemical analysis method includes cyclic voltammetry (CV), linear sweep voltammetry (LSV), square wave voltammetry (SWV), differential pulse voltammetry (DPV), amperometric i-t curve (IT), electrochemical impedance spectroscopy (EIS) or open circuit potential-time (OCP).

Optionally, the control parameters include potential applied, current applied, reaction time, detection temperature, reagent concentration or signal capture range.

Optionally, the conversion formula includes a calculation formula or a conversion equation.

Optionally, the test result includes sample concentration or sample content percentage.

Optionally, the portable chip connects to the computer through a burning device, the plurality of analyzing process of the portable chip being burned or erased by the process editing program.

Optionally, the electrochemical analyzer connects to the portable chip through a chip interface, and executes the plurality of analyzing process of the portable chip.

According the above, the present invention provides an operation method of an electrochemical analyzer, and by burning the operational process into a portable chip, the electrochemical analyzer is able to perform electrochemical analysis to a specific target according to the analyzing process stored in the portable chip, and showing the test results directly on the display of the electrochemical analyzer without the need to connect a data analysis apparatus or a computer device for process flow configurations, thus provides convenience and efficiency to detection applications. In addition, according to the present invention, the electrochemical analyzer can detect and analysis different analytes by swapping different portable chips without reconfiguring the operational process. Accordingly, the detection and analysis can be easily adjusted according to different samples, thus provide more features to the detection function, and wider variety of usage.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flow chart of an online electrochemical analyzing process in accordance with an embodiment of the present invention;

FIG. 2 is a flow chart of an operation method of an electrochemical analyzer in accordance with an embodiment of the present invention;

FIG. 3 is a schematic view of an electrochemical simulation system in accordance with an embodiment of the present invention;

FIG. 4 is a schematic view of an electrochemical analyzer in accordance with an embodiment of the present invention;

FIG. 5 is a schematic view of a process editing program in accordance with an embodiment of the present invention;

FIGS. 6A to 6E are actual operation screenshots of the process editing program in accordance with an embodiment of the present invention.

### DETAILED DESCRIPTION OF THE PREFERRED EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

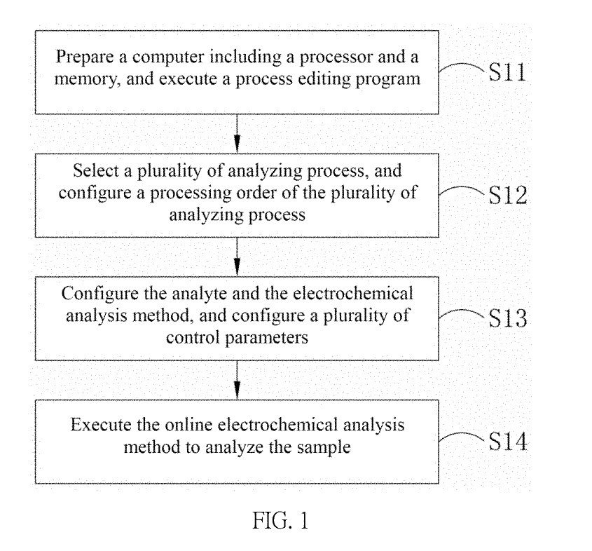

FIG. 1 is a flow chart of an online electrochemical analyzing process in accordance with an embodiment of the present invention. According to FIG. 1, the online electrochemical analyzing process of an electrochemical analyzer comprises the following steps (S11-S14):

Step S11: Prepare a computer including a processor and a memory to execute a process editing program. The computer herein includes personal computers, laptops, servers, and so on, the memory is a computer-readable medium with stored software programs, including hard disk, solid state hard disk, flash memory or phase change memory. The processor includes one or more single or multi core processors connected to the memory and execute instructions stored in the memory to execute the software program. The online electrochemical analysis setting process of the present embodiment may be executed by the computer to perform the configurations of step S11 to step S13.

Step S12: Select a plurality of analyzing process, and configure a processing order of the plurality of analyzing process. In the process editing program, initially, the analyzing processes are designed according to the analysis to be performed, and configure the processing order of the analyzing processes at the same time; the analyzing process includes sample detection process, electrochemical analysis initiation process, detection signal capturing process, or detection signal conversion process. Specifically, the sample detection process configures the analysis chip of the electrochemical analyzer according to the type of analyte and sample status during detection to determine whether enough sample has been received, for example, if the potential (voltage) change detected exceed a preset value, it may be determined that the sample has been placed and the electrochemical analyzing process may be initiated. After the initiation, select which electrochemical analysis method to be performed, such as performing one or more electrochemical analysis, and also apply the setting into the process editing program. Next, also apply the detection signal acquisition and the signal conversion process after obtaining the signal into the process editing program. In other words, the steps which require manual operation in conventional electrochemical analysis may be pre-designed, and configured beforehand in the process editing program.

Step S13: Configure the analyte and the electrochemical analysis method, and configure a plurality of control parameters. Regarding the electrochemical analyzing process configured in step S12, further select a corresponding electrochemical analysis method according to the analyte and the required analysis results. The electrochemical analysis methods include cyclic voltammetry, linear sweep voltammetry, square wave voltammetry, differential pulse voltammetry, amperometric i-t curve, electrochemical impedance spectroscopy or open circuit potential-time. Additionally, each control parameters of the analysis may be configured according to different electrochemical methods, in which the control parameters include potential applied, current applied, reaction time, detection temperature, reagent concentration or signal capture range.

Step S14: Execute the online electrochemical analysis method to analyze the sample. After the selection of the analyte and the electrochemical analysis method, and the configuration of the parameters are complete, connect the electrochemical analyzer to the computer, and place the sample onto the analysis chip, then execute the configured analyzing process described above by the electrochemical analyzer. The detected potential or current data may be obtained based on different electrochemical analysis methods, and execute the analysis through the connected computer and present the results to the operator.

The online electrochemical analyzing process described above indicates that the electrochemical analysis method may be executed directly by the electrochemical analyzer which receives the sample and performs the analysis, and then processed by the connected computer to obtain the test result of the sample. However, regarding the online electrochemical analyzing process, the use becomes more restricted under the connected situation and is not suited for portable or mobile detection. Therefore, the present invention further provides a disconnected operation method, which is an offline electrochemical analyzing process described in the embodiment below.

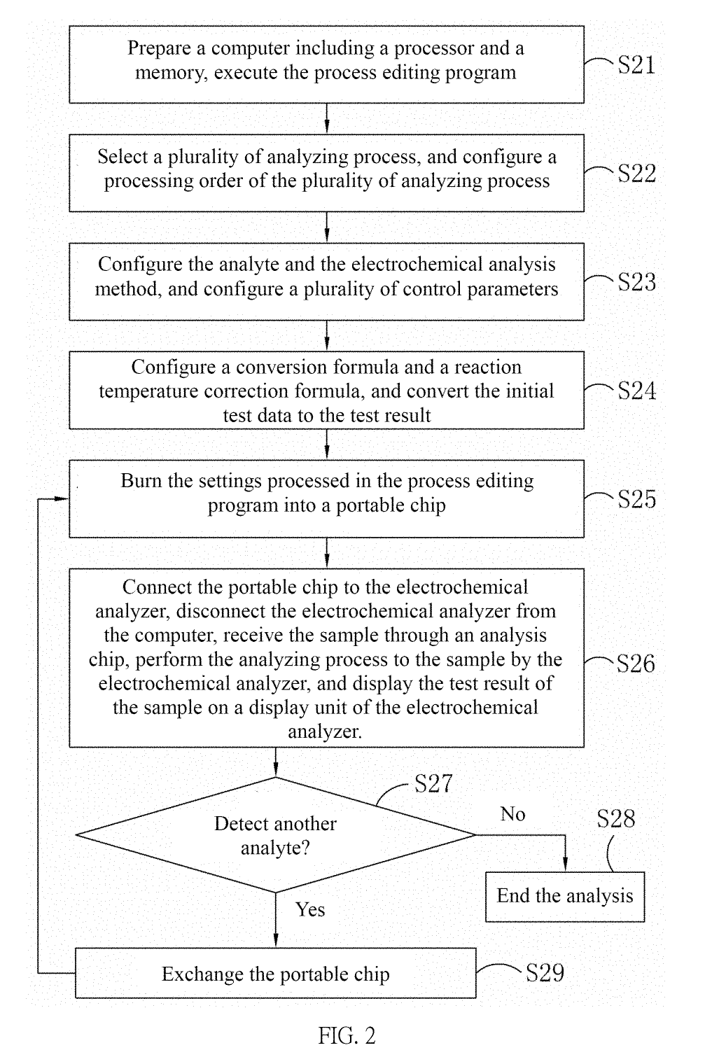

FIG. 2 is a flow chart of an operation method of an electrochemical analyzer in accordance with an embodiment of the present invention. With reference to FIG. 2, the operation method of an electrochemical analyzer comprises the following steps (S21-S29):

Step S21 to step S23: Prepare a computer including a processor and a memory, execute the process editing program and configure the analyzing process. These steps are the same as the step S11 to step S13 of FIG. 1, where the user configure the analyzing process through the process editing program. Therefore, detailed description of the steps above can refer to the description regarding FIG. 1, and the same technical means will not be repeated.

Step S24: Configure a conversion formula and a reaction temperature correction formula to convert an initial test data to a test result. Compared to the online electrochemical analysis method executed in step S14, although the online electrochemical analysis method is able to select the parameters of various arithmetic formula or equations stored in computers or servers, but tests in general only requires specific conversion formula and reaction temperature correction formula. Therefore, in order to realize an offline electrochemical analysis, the required sample type, corresponding electrochemical analysis method, control parameters, conversion formula, temperature correction formula and so on are pre-selected and configured to enable the electrochemical analyzer to perform data interpretation directly based on the above configurations and convert such data into meaningful test results.

Step S25: Burn the settings processed in the process editing program into a portable chip. The configuration of all the above electrochemical analysis analyzing processes is performed by the process editing program, and the whole analyzing process may be burned into the portable chip. The portable chip may include memory chips, and the electrochemical analysis analyzing process and the related settings may be stored in the portable chip through the process editing program. Therefore, the corresponding analyzing process for different analytes may be stored in different chips, and the chips can be exchanged according to the type of analyte to perform the corresponding analyzing process during actual tests.

Step S26: Connect the portable chip to the electrochemical analyzer, disconnect the electrochemical analyzer from the computer, receive the sample through an analysis chip, perform the analyzing process to the sample by the electrochemical analyzer, and display the test result of the sample on a display unit of the electrochemical analyzer. This step includes the previous steps S22˜24: Using the configured process before the test, and execute the configured control parameters. At the same time, execute the configured electrochemical analyzing process, and further select a corresponding electrochemical analysis method according to the analyte and the required analysis results. The electrochemical analysis methods include cyclic voltammetry, linear sweep voltammetry, square wave voltammetry, differential pulse voltammetry, amperometric i-t curve, constant-current method, electrochemical impedance spectroscopy or open circuit potential-time. Additionally, each control parameters of the analysis may be configured according to different electrochemical methods, in which the control parameters include potential applied, current applied, reaction time, detection temperature, reagent concentration or signal capture range. Then, capture the configured data signal and apply them to the configured conversion formula to convert the initial test data to test results. Since the detected signals are often current or potential signals, the initial test data would go through various addition, subtraction, average, maximum and minimum calculations, and then converted to the required test results through the conversion equations including sample concentration or sample content percentage, etc. The parameters of each formula or equation may be adjusted according to former analysis results, so that the test results can meet the actual situations.

Step S27: Decide whether to detect another analyte. If not, proceed to step S28, and if so, proceed to step S29. After completing the above test results, user may perform different electrochemical analyzing processes to different analytes, unlike the known portable electrochemical analyzers designed towards the detection of only a single analyte, such as blood glucose meters. Usually when detecting a different analyte, it would be necessary to change to another analyzer or connect to a computer and perform a different analysis with the received data. However, the electrochemical analyzer of the present embodiment only needs to exchange the portable chip for a different analyte to perform different types of analysis without the need for the above steps of conventional analyzers.

Step S28: End the analysis. If only one electrochemical analysis is required, the analyzing process is completed after the test result is generated, providing the detected concentration or percentages of the sample.

Step S29: Exchange the portable chip. When required to target other different analytes for the analysis, the electrochemical analyzer may exchange the connected portable chip to perform the analyzing process for a new analyte through the electrochemical analyzer, the analysis chip may also be exchanged according to the new analyte, for example, connecting a chemical chip having reaction reagents to react to the analyte of the sample, and detect the potential/current data by the electrochemical analyzer to obtain new test result through conversion.

The portable chip may be connected to the electrochemical analyzer via a chip interface. The electrochemical analyzer of the present embodiment includes a processor, a memory, a controller, a detector and a display screen. Wherein, the chip interface of the electrochemical analyzer includes a slot, a chip reader, a memory device reader, etc. When the portable chip is connected to the chip interface, the processor may read the processes burned inside the chip, and control the controller of the electrochemical analyzer to perform the actual analysis. For example, when the sample is dropped on the analysis chip (such as, a chemical test strip), the controller monitors the generated potential or current according to the sample detection process, when the monitoring value exceeds the predetermined threshold, the electrochemical analyzing process is initiated. At this time, the controller may apply a potential to the sample and receive the reaction current, and capture the potential and current data during the reaction time according to the selected electrochemical analysis method. These initial test data will then be converted by the conversion formula to calculate the concentration or percentage of the sample. The test results may be displayed on a display screen of the electrochemical analyzer, so that the user does not need to read and interpret the potential/current data and graphics to obtain the final test results.

Through the execution of the above steps, one is able to configure the whole process and control parameters through the process editing program in the computer, and burn it into a portable chip. Therefore, operation of the electrochemical analyzer will only need to connect the portable chip and execute the contents burned inside to complete the analysis and generate final results. Although the electrochemical analyzer of the present embodiment may also connect to a computer during actual practice, the electrochemical analyzer can also operate offline and independently by including the portable chip, and simulate the entire function of an online analysis of the electrochemical analyzer.

In the case where both the electrochemical analyzer and the portable chip may be made portable through miniaturization design, user may easily carry the electrochemical analyzer of the present embodiment when performing electrochemical analysis, without the need to transfer detection signals online for analysis, effectively improves the operational convenience and practicality.

When targeting different analytes, the corresponding electrochemical analyzing processes may be configured and burned into portable chips, and if the test results are found to be deviated by actual practice of the analysis or through experimental comparison, the portable chips may be reconnected to the computer and restart step S21 once again to erase the former settings and readjust the processes or parameters by the process editing program, and burn into the portable chip again. In this way of operation, the electrochemical analyzer may easily simulate various kinds of analyzing process while adjusting possible errors swiftly, which is greatly beneficial to the development of electrochemical analyzers.

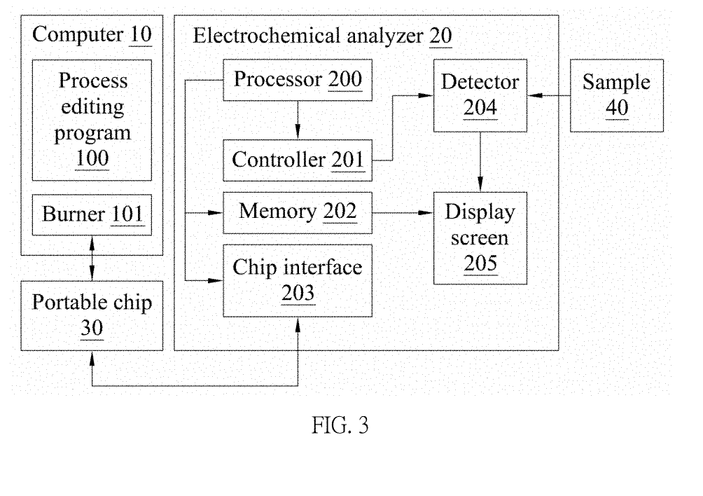

FIG. 3 is a schematic view of an electrochemical simulation system in accordance with an embodiment of the present invention. According to FIG. 3, the electrochemical simulation system includes computer 10, electrochemical analyzer 20 and portable chip 30. Wherein, the computer 10 may be a personal computer, a laptop, or a server etc. which is installed with the process editing program 100 as the software for configuring electrochemical analyzing processes. The computer 10 further includes a burner 101 to burn or erase data in the portable chip 30. The electrochemical analyzer 20 includes processor 200, controller 201, memory 202, chip interface 203, detector 204 and display screen 205. The portable chip 30 may be inserted into the slot of the chip interface 203, such as Universal Serial Bus (USB) or Electronic Industry Alliance (EIA) serial communication interface standard RS-232, RS-485. After the connection, the processor 200 reads the processes burned in the portable chip 30, and sends out control signals to the controller 201 to activate the electrochemical analyzer 20 and perform the analyzing process.

When the sample 40 for analysis enters the detector 204, the controller 201 applies a potential to the sample and receive the reaction current, and capture the potential and current data during the reaction time according to the selected electrochemical analysis method. These data will then be converted by the conversion formula to calculate the concentration or percentage of the sample, and the results will be displayed on the display screen 205 of the electrochemical analyzer 20, or stored in the memory 202.

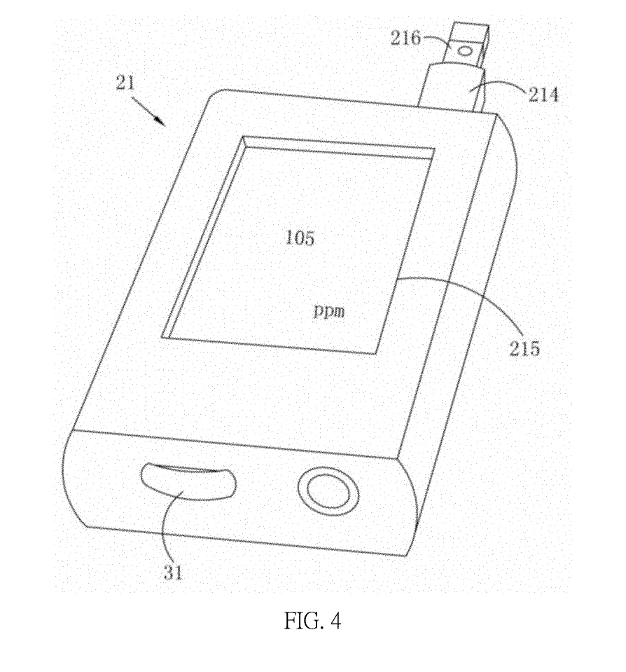

FIG. 4 is a schematic view of an electrochemical analyzer in accordance with an embodiment of the present invention. According to FIG. 4, the electrochemical analyzer 21 is a portable handheld device, which includes a display screen 215 for displaying the test results. In addition, the electrochemical analyzer 21 includes a ship slot to connect the portable chip 31 to the electrochemical analyzer 21 and to perform the analyzing process burned in the portable chip 31. When the analysis is actually performed, the detector 214 may include a corresponding chemical test strip 216, and when the sample being dropped on the chemical test strip 216 reaches a certain amount or concentration, the detector 214 applies a potential and detect the reaction current. The detected data being calculated by the processor of the electrochemical analyzer 21 to obtain the concentration of the sample and display it on the display screen 215. When detecting a different sample, the electrochemical analyzer 21 only needs to exchange to the corresponding portable chip 31 and use the corresponding chemical test strip 216 to perform another test to a different sample. Since both the electrochemical analyzer 21 and the portable chip 31 are designed to be suitable for carrying, it would not be limited by the lab space or the connection with certain computer, providing more flexibility to the usage and operation.

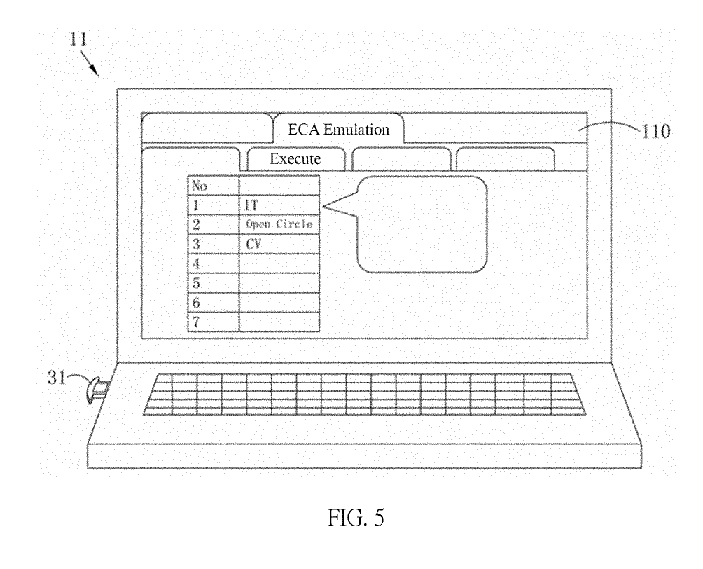

FIG. 5 is a schematic view of a process editing program in accordance with an embodiment of the present invention. According to FIG. 5, the process editing program 110 may be installed in a laptop 11, and the portable chip 31 connects to the laptop 11 through USB interface. When executing the process editing program 110, the analyzing process for the electrochemical analysis may be burned into the portable chip 31, so as to coordinate with the operation of the electrochemical analyzer 21.

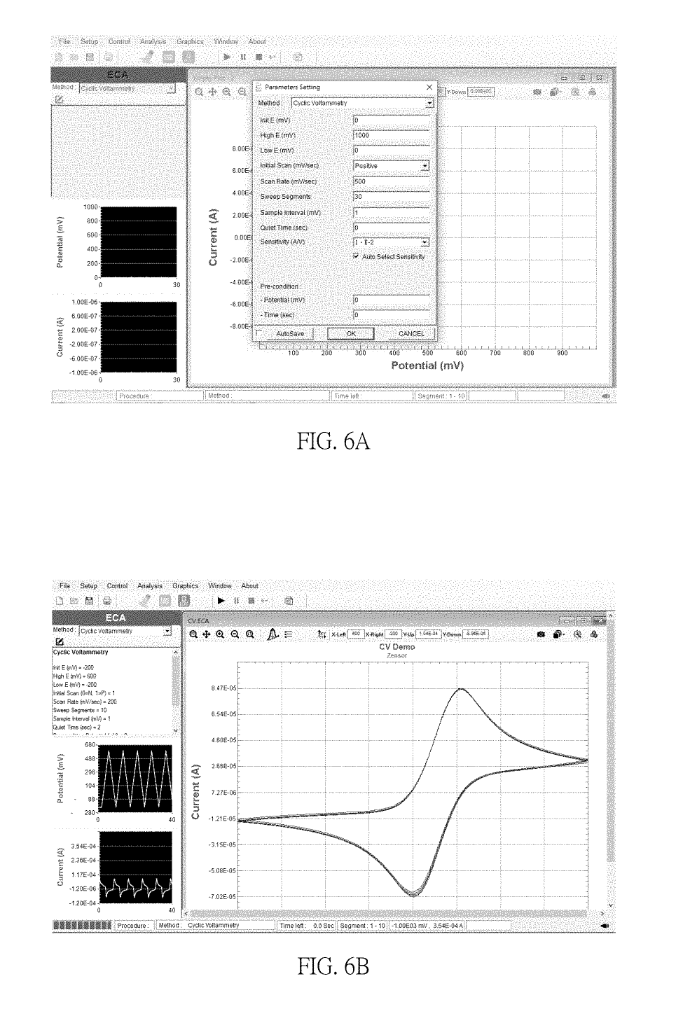

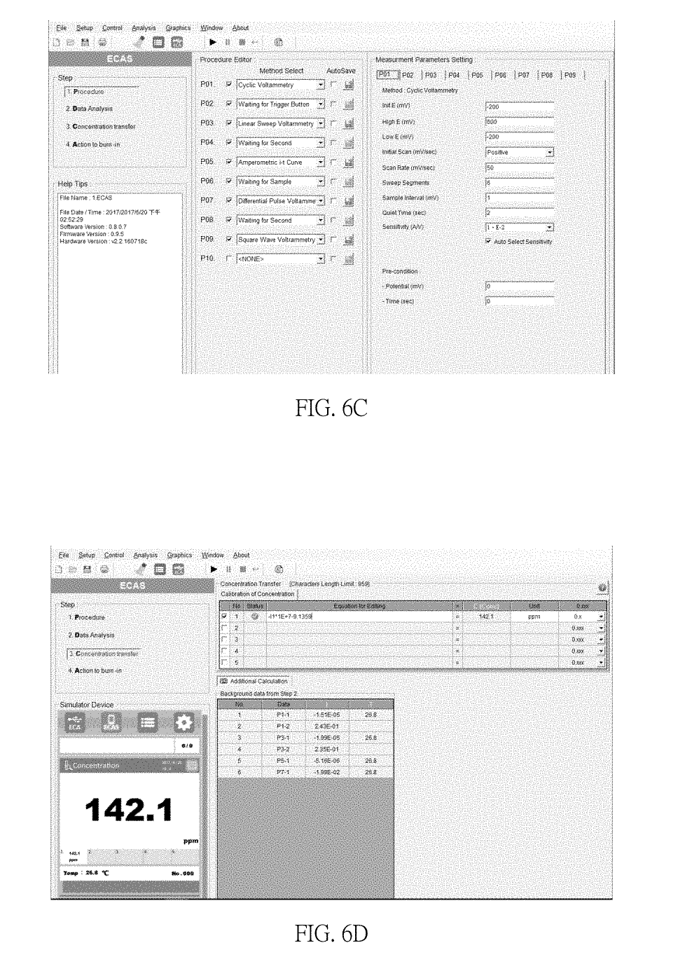

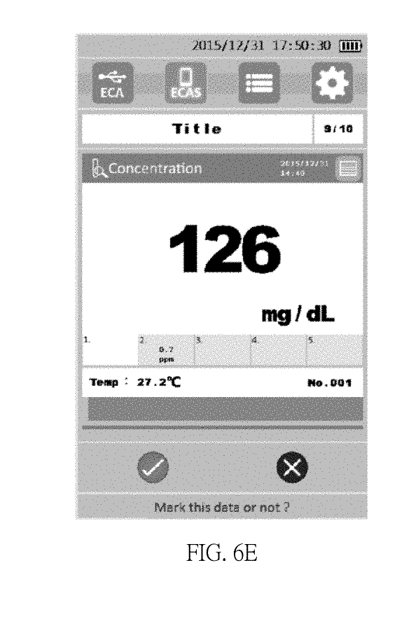

Specific embodiments of the present invention will be described hereinafter. FIGS. 6A to 6E are actual operation screenshots of the process editing program in accordance with an embodiment of the present invention, with FIG. 6A being the operation screenshot of selecting the electrochemical analysis method and setting the parameters. Wherein, the main function area in the upper space may include functions such as File/Setup/Control/Analysis/Graphics/Window/Assistant, and may also include hotkeys for online mode, offline mode and operational control etc. “File” includes saving the records of each analysis, batch files to txt, or establishing concentration calculation template to set a calibration curve. “Setup” includes system setup of the computer, mode change, read measurement records or chip data, and hardware self-test etc. Wherein, the potential window and current window on the bottom left corner may display real time potential waveform or current waveform with numerical data. The main screen on the bottom right corner includes the operation screen for the setting of electrochemical analysis method and parameters. In the present embodiment, the electrochemical analysis method includes cyclic voltammetry, linear sweep voltammetry, square wave voltammetry, differential pulse voltammetry, amperometric i-t curve, electrochemical impedance spectroscopy (EIS) or open circuit potential-time. The parameter limits of each method will be described respectively below.

For cyclic voltammetry, the adjustable parameters of the present embodiment include initial potential, high and low limit of potential scan, initial scanning direction, potential scan rate, sweep segments, data sampling interval, quiescent time before potential scan, and sensitivity scale etc. In addition, the parameters further include set potential and set time for pretreatment. The above parameters are the main adjustment conditions of the present invention. However, the present invention is not limited thereto and other parameters involving cyclic voltammetry may also be included in the scope. Regarding the parameters described above, the operable range of the present embodiment is shown in Table 1.

TABLE 1

| Description | Parameters | Range |
|---|---|---|
| Initial potential | Init E (mV) | −2000-+2000 |
| High limit of potential scan | High E (mV) | −2000-+2000 |
| Low limit of potential scan | Low E (mV) | −2000-+2000 |
| Initial scan direction | Initial Scan (mV/sec) | Negative or Positive |
| Potential scan rate | Scan Rate (mV/Sec) | 1-5000 |
| Sweep segments, each | Sweep Segments | 1-10000 |
| segments is half cycle | | |
| Data sampling interval | Sample interval (mV) | 1-200 |
| Quiescent time before | Quiet Time (sec) | 0-10000 |
| potential scan | | |
| Sensitivity scale | Sensitivity (A/V) | 1e−7-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

For linear sweep voltammetry, the adjustable parameters of the present embodiment include initial potential, final potential, potential scan rate, data sampling interval, quiescent time before potential scan, sweep segments, and sensitivity scale etc. In addition, the parameters further include set potential and set time for pretreatment. The operable range of the present embodiment is shown in Table 2.

TABLE 2

| Description | Parameters | Range |
|---|---|---|
| Initial potential | Init E (mV) | −2000-+2000 |
| Final potential | Final E (mV) | −2000-+2000 |
| Potential scan rate | Scan Rate (mV/Sec) | 1-5000 |
| Data sampling interval | Sample interval (mV) | 1-200 |
| Quiescent time before | Quiet Time (sec) | 0-10000 |
| potential scan | | |
| Sweep segments, each | Sweep Segments | 1-10000 |
| segments is half cycle | | |
| Sensitivity scale | Sensitivity (A/V) | 1e−7-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

For differential pulse voltammetry, the adjustable parameters of the present embodiment include initial potential, final potential, potential increment, potential pulse amplitude, potential pulse width, data sampling width, pulse period, quiescent time before potential scan, and sensitivity scale etc. In addition, the parameters further include set potential and set time for pretreatment. Regarding the main adjustment conditions of the parameters described above, the operable range of the present embodiment is shown in Table 3.

TABLE 3

| Description | Parameters | Range |
|---|---|---|
| Initial potential | Init E (mV) | −2000-+2000 |
| Final potential | Final E (mV) | −2000-+2000 |
| Potential increment | Incr E (mV) | 1-250 |
| Potential pulse | Amplitude (mV) | 5-250 |
| amplitude | | |
| Potential pulse width | Pulse Width (ms) | 4-400 |
| Data sampling width | Sample Width (ms) | 1-<pulse width |
| Pulse period | Pulse Period (ms) | 10-1000 |
| Quiescent time before | Quiet time (sec) | 0-10000 |
| potential scan | | |
| Sensitivity scale | Sensitivity (A/V) | 1e−7-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

For open circuit potential-time, the adjustable parameters of the present embodiment include experiment running time, data sampling interval, potential range display mode, high and low limit of potential scan, and quiescent time before potential scan etc. Regarding the main adjustment conditions of the parameters described above, the operable range of the present embodiment is shown in Table 4.

TABLE 4

| Description | Parameters | Range |
|---|---|---|
| Experiment running time | Running Time (sec) | 1-100000 |
| Data sampling interval | Sample interval (ms) | 1-3000 |
| Potential range | E scale mode | Fixed (User Defined) |
| display mode | | Auto (Auto Range) |
| High limit of | High E Limit (mV) | −2000-2000 |
| potential scan | | |
| Low limit of | Low E Limit (mV) | −2000-2000 |
| potential scan | | |
| Quiescent time before | Quiet time (sec) | 0-10000 |
| potential scan | | |

For square wave voltammetry, the adjustable parameters of the present embodiment include initial potential, final potential, potential increment, potential pulse amplitude, potential pulse width, data sampling width, quiescent time before potential scan, and sensitivity scale etc. In addition, the parameters further include set potential and set time for pretreatment. Regarding the main adjustment conditions of the parameters described above, the operable range of the present embodiment is shown in Table 5.

TABLE 5

| Description | Parameters | Range |
|---|---|---|
| Initial potential | Init E (mV) | −2000-+2000 |
| Final potential | Final E (mV) | −2000-+2000 |
| Potential increment | Incr E (mV) | 1-250 |
| Potential pulse amplitude | Amplitude (mV) | 5-250 |
| Potential pulse width | Period (ms) | 10-1000 |
| Data sampling width | Sample Width (ms) | 1-<Period/2 |
| Quiescent time before | Quiet time (sec) | 0-10000 |
| potential scan | | |
| Sensitivity scale | Sensitivity (A/V) | 1e−7-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

For electrochemical impedance spectroscopy, the adjustable parameters of the present embodiment include initial potential, data sampling interval, frequency range, high and low limit of frequency, potential amplitude, Fourier transform (Above 100 Hz), experiment running time, quiescent time before potential scan, resistance sensitivity range display mode, and sensitivity scale etc. In addition, the parameters further include set potential and set time for pretreatment. Regarding the main adjustment conditions of the parameters described above, the operable range of the present embodiment is shown in Table 6.

TABLE 6

| Description | Parameters | Range |
|---|---|---|
| Initial potential | Init E (mV) | −2000-+2000 |
| Data sampling interval | Sample interval (ms) | 1-3000 |
| Frequency range | Frequency (Hz) | 0.01-1000000 |
| High limit of frequency | High Frequency (Hz) | 0.01-1000000 |
| Low limit of frequency | Low Frequency (Hz) | 0.01-1000000 |
| Potential amplitude | Amplitude (V) | 0.01-1 |
| Fourier transform | FT (Above 100 Hz) | Yes or No |
| (Above 100 Hz) | | |
| Experiment running time | Running Time (sec) | 100-100000000 |
| Quiescent time before | Quiet time (sec) | 0-10000 |
| potential scan | | |
| Resistance sensitivity | Ω Scale Mode | 1, 2, 3, Auto Range |
| range display mode | | |
| Sensitivity scale | Sensitivity (A/V) | 1e−9-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

For amperometric i-t curve, the adjustable parameters of the present embodiment include initial potential, data sampling interval, experiment running time, quiescent time before potential scan, current sensitivity range display mode, and sensitivity scale etc. In addition, the parameters further include set potential and set time for pretreatment. Regarding the main adjustment conditions of the parameters described above, the operable range of the present embodiment is shown in Table 7.

TABLE 7

| Description | Parameters | Range |
|---|---|---|
| Initial potential | Init E (mV) | −2000-+2000 |
| Data sampling interval | Sample interval (ms) | 1-3000 |
| Experiment running time | Running Time (sec) | 100-100000000 |
| Quiescent time before | Quiet time (sec) | 0-10000 |
| potential scan | | |
| Current sensitivity | I Scale Mode | 1, 2, 3, Auto Range |
| range display mode | | |
| Sensitivity scale | Sensitivity (A/V) | 1e−7-1e−2 |

Pretreatment

| | | |
|---|---|---|
| Set potential for | Potential (mV) | −2000-+2000 |
| pretreatment | | |
| Set time for | Time (sec) | 0-10000 |
| pretreatment | | |

In addition, the process editing program of the present embodiment may further include hardware self-test procedures to assist users when verifying hardware conditions, wherein the test may be an internal circuit test and an external circuit test, with the internal circuit test being used for detecting internal circuit conditions of the system, while the external circuit test utilizes a self-test sensor to detect whether the system is functioning properly. When the selection of analysis method and the configuration of parameters are complete, user may select Run (R), Pause/Resume or Stop (S) the analysis from the Control options, or click the shortcut icon directly as shown in FIG. 6B. As shown in the figure, the potential window and current window on the left displays real time potential and current conditions, while the experimental graphics is shown on the right, with the form of presentation regarding current and potential, colors, size of the axis or orders being adjustable according to requirements. Since the synchronized test values of the potential window and current window can be observed simultaneously, it may benefit the user when progressing data analysis and the experiment.

The experimental graphics in the figure shows the captured potential and current signals of the sample, which is usually compared to the graphics of the target analyte to determine the test results. This process may be done by opening the stored target files and overlapping the experimental graphics with the target graphics, or opening a plurality of windows and compare with a plurality of targets. Furthermore, for the ease of analysis, one may also use the default analysis tools to perform data analysis, such as calculating the Maximum (MAX), Summation (SUM), Average (AVG), Peak height (PEAK), or Area (AREA) of a certain interval of the graphics, and save the results or compare them to the target values.

FIG. 6C provides the operation screenshots of an offline electrochemical analyzing process. The electrochemical experiments described above may be performed with the analyzer being connected to a computer, which allows the adjustment of operation methods and parameters at any time, and test results may also be compared with the database and further adjust the parameters. On the other hand, in order to allow the electrochemical analyzer to operate offline as being disconnected from the computer, and provide a portable analyzing device for the user, the present embodiment provide the following operational process, including configuring the program (Procedure), analyzing the data (Data Analysis), transferring the data into concentration (Concentration Transfer) and burning the parameters (Action to Burn).

The main options of the Procedure include step editing and setting experimental parameters. The step editing of the present embodiment may edit a maximum of 10 steps (P01-P10), but the present invention is not limited thereto, as one may also store commonly used steps in advance to be loaded during operations. Each step may include waiting for trigger (Waiting for Trigger Button), waiting time (Waiting for Second), waiting for the sample (Waiting for Sample) and execute the electrochemical analysis method above (Method Select). To assist the user to initiate the experiment, the user may define hint words to display on screen when the configuration is complete to remind the user to start the experiment, and the process will proceed to the next step only when the Start button on the screen is pressed. In addition, the limit of waiting time also need to be set to prevent machine idling when the user forgot to proceed the operation, the process automatically terminates when the set time expires. The Waiting for Trigger time may be 1 to 300 seconds. The Waiting for Sample function allows the user to customize the test strip, and when the sample reaches the surface of the electrodes, the system may automatically determine whether to perform the analysis according to the parameter settings of the user, the user only need to configure the potential for trigger (E for Trigger (mV)) and the current level for trigger (I of level for Trigger (uA)), such as testing the potential and current when introducing the sample using Amperometry methods to confirm the potential for trigger and the current level for trigger, and set such parameters as the sample triggering parameters. The potential for trigger may be −2000 to +2000 V and the current level for trigger may be ±1 to ±10000 uA. The Waiting for Second sets the step progress or electrochemical reaction time, the process proceeds to the next step after the set time expired. The Waiting for Second may be 100 to 30000 seconds.

After the Procedure, the process moves forward to Data Analysis which performs the experiment and data analysis by performing the analyzing process configured above, and analyzing the data. The definition of the data must be determined (Data Define) in order to achieve the following step of Concentration Transfer, the Data Define includes information such as data segments (Segment), data range (Range (X0)−Range (X1)), data type (Type), data results (I) and operating temperature (Temperature). In addition, a calibration curve also needs to be configured, including a concentration transfer curve and a temperature correction curve. The calibration curve can be obtained by calibration curve templates or adjust the slope, intercept or other parameters of the curve equation based on the test results. After configuring the conversion formula of concentration, the signals of the analyte may be transferred to the actual test results, such as the concentration of the target in a sample. The system can save a plurality of test results, and present the plurality of concentrations for the user to observe or adjust the parameters of the calibration curve accordingly. For example, as shown in FIG. 6D, the test results includes the 6 values shown in column I on the right side, and the concentration of the sample obtained by the conversion formula is 142.1 ppm.

After configuring the concentration transfer or the calibration curve, the selected method and the parameter settings above are all burned into a portable chip, the chip may include a burned count and a device matching serial number to avoid using abnormal chip and causing wrong detection results. After burning the chip, the chip may be inserted into a chip slot of the electrochemical analyzer, and disconnect the electrochemical analyzer from the computer, so the user may carry the portable electrochemical analyzer to perform analysis towards specific analytes. Considering the variables from different test locations or environments, the offline electrochemical analyzer may configure relative settings such as date, temperature, display and sound cues so the test may match the actual test conditions.

When performing the actual test, the electrochemical analyzer may connect an analysis chip, receive the sample through the analysis chip, and perform the electrochemical analysis steps according to the burned analyzing process described above. The detection signals are then transferred to concentration by the configured concentration conversion formula and to be shown on a display screen of the electrochemical analyzer, as shown in FIG. 6E, the test results may be saved in the chip, including detection data, date and temperature etc. The most beneficial part of the offline electrochemical analyzing process is that after completing the test of one target analyte, the user only needs to swap to another burned chip to test the concentration or content percentage of another target analyte without the need to exchange the electrochemical analyzer, which provides more convenience during analysis. On the other hand, the burned chip may also be erased and burn new analyzing process for new targets repeatedly according to requirements, which provides more variety of choices in use.

It should be noted that in the foregoing embodiments, the description of each embodiment has respective focuses. For a part that is not described in detail in a certain embodiment, reference may be made to related descriptions in other embodiments.

The foregoing descriptions are merely illustrative of specific embodiments of the present invention, and are not intended to limit the protection scope of the present invention. Any variation or replacement readily figured out by persons skilled in the art within the technical scope disclosed in the present application shall fall within the protection scope of the present application. Therefore, the protection scope of the present invention shall be subject to the protection scope of the claims.

What is claimed is:

1. An operation method of an electrochemical analyzer, the operation method comprises the following steps:
preparing a computer including a processor and a memory, and configure an online electrochemical analysis setting process by the computer;
configuring a conversion formula and a reaction temperature correction formula through a process editing program, convert an initial test data of an analyte and a corresponding electrochemical analysis method to a test result of the analyte;
burning the settings processed in the process editing program into a portable chip through the processor;
connecting the portable chip to the electrochemical analyzer, disconnect the electrochemical analyzer from the computer, receive a sample through an analysis chip, perform an offline electrochemical analyzing process by the electrochemical analyzer to conduct electrochemical analysis to the sample, and display the test result of the sample on a display unit of the electrochemical analyzer.

2. The method of claim 1, wherein the online electrochemical analysis setting process comprises the following steps:
executing the process editing program stored in the memory through the processor;
selecting a plurality of analyzing process through the process editing program, and configure a processing order of the plurality of analyzing process;
configuring the analyte and the corresponding electrochemical analysis method through the process editing program, and configure a plurality of control parameters.

3. The method of claim 2, wherein the plurality of analyzing processes include a sample detection process, an electrochemical analysis initiation process, a detection signal capturing process, or a detection signal conversion process.

4. The method of claim 2, wherein the electrochemical analysis method includes cyclic voltammetry, linear sweep voltammetry, square wave voltammetry, differential pulse voltammetry, amperometric i-t curve, electrochemical impedance spectroscopy or open circuit potential-time.

5. The method of claim 2, wherein the control parameters include potential applied, current applied, reaction time, detection temperature, reagent concentration or signal capture range.

6. The method of claim 2, wherein the conversion formula includes a calculation formula or a conversion equation.

7. The method of claim 2, wherein the test result includes sample concentration or sample content percentage.

8. The method of claim 2, wherein the portable chip connects to the computer through a burning device, the plurality of analyzing process of the portable chip being burned or erased by the process editing program.

9. The method of claim 2, wherein the electrochemical analyzer connects to the portable chip through a chip interface, and executes the plurality of analyzing process of the portable chip.
